(19) United States
(12) Patent Application Publication
(10) Pub. No.: US 2010/0150398 A1
(43) Pub. Date: Jun. 17, 2010

(54) MULTILINGUAL ACCEPTANCE INFORMATION PROCESSING METHOD AND SYSTEM BASED ON IMAGE RECOGNITION

(75) Inventors: Kibaek Lee, Daejeon (KR); Dong-Gil Na, Daejeon (KR); Hoon Jung, Daejeon (KR); Jong Heung Park, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/603,694

(22) Filed: Oct. 22, 2009

(30) Foreign Application Priority Data
Dec. 17, 2008 (KR) 10-2008-0128733

(51) Int. Cl. G06K 9/00

(52) U.S. Cl. 382/101

(57) ABSTRACT

Provided is an image recognition-based multilingual acceptance information processing method and system. In the case of processing incoming mail, when a domestic address is written in a foreign language, it is converted into a correct native address written in a native language that is then mapped on an attached barcode or a newly generated barcode. Also, when it is impossible to analyze the characters through character recognition, the read image information is transmitted to a remote video coding center, and a specialist converts it into a native language to map the information on the barcode. Further, when a mailman reads the barcode in the final delivery process, a detailed native address is displayed on a display device such as a personal digital assistant (PDA).

### CROSS-REFERENCE TO RELATED APPLICATION

This application claims priority to and the benefit of Korean Patent Application No. 10-2008-0128733 filed in the Korean Intellectual Property Office on Dec. 17, 2008, the entire contents of which are incorporated herein by reference.

### BACKGROUND OF THE INVENTION

(a) Field of the Invention

The present invention relates to a multilingual acceptance information processing method and system based on image recognition.

(b) Description of the Related Art

Regarding the conventional process for processing international mail or outbound courier mail, an operator reads the recipient's address that is written in a foreign language and inputs the corresponding mail address just before the international mail is transferred to a processing workplace such as an international post office and is automatically inserted into an automatic sorting machine after being loaded on a conveyor. Mail is sorted and processed after passing through the custom service, and the same is delivered to the recipient by using domestic mail facilities (e.g., a mail sorting center, an exchange center, and vehicles). In this instance, since the address the operator reads is written in various languages, it influences the operators' mail processing rate depending on his performance and skillfulness.

That is, since the operator must read the recipient address written in many languages, find the postal code to perform a key-in process, and the other operator (mailman, etc.) must also read the multilingual recipient address, they have many difficulties in processing the mail.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an image recognition-based multilingual acceptance information processing method and system having advantages of improving job convenience by easily converting a multilingual recipient address into an address written in a native language, and applying the converted information to the subsequent logistics process.

An exemplary embodiment of the present invention provides a multilingual acceptance information processing system including: a mail image recognizing unit for recognizing image information of input mail, the image information including address information of the mail and barcode information of the mail; a multilingual address/barcode extracting unit for receiving image information from the mail image recognizing unit and extracting address information and barcode information of the mail form the image information; an address information matching unit for receiving the address information extracted by the multilingual address/barcode extracting unit, comparing the received address information with pre-stored native address information mapped on multilingual languages, and extracting native address information corresponding to the address information; and a multilingual address/barcode information mapping unit for assigning a postal code corresponding to the native address information extracted by the address information matching unit, mapping the native address information and the barcode information, and generating acceptance information including the postal code.

Another embodiment of the present invention provides a multilingual acceptance information processing method including: extracting address information and barcode information from image information when collecting the image information of mail; determining whether native address information is extracted by mapping the extracted address information and pre-stored native address information mapped on multilingual languages; generating acceptance information on the mail in connection with the native address information and the barcode information when native address information corresponding to the address information is extracted; and storing the generated acceptance information.

### BRIEF DESCRIPTION OF THE DRAWINGS

FIG. 1 shows a configuration diagram of an image recognition-based multilingual acceptance information processing system according to an exemplary embodiment of the present invention.

FIG. 2 shows a flowchart of a method for processing mail by using the system according to the exemplary embodiment of the present invention.

FIG. 3 shows a flowchart of a method for a mailman to deliver mail according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

A system and method for recognizing information including the recipient's address, name, and telephone number written on mail in a multilingual manner and processing the same according to an exemplary embodiment of the present invention will now be described in detail with reference to accompanying drawings.

In the exemplary embodiment of the present invention, multiple languages imply languages of other countries except a native language. For example, if Korean is a native language, Chinese, English, and Japanese can be used as multiple languages. Here, the native language may be one more according to country. Hereinafter, address information written in a native language will be called “native address information”.

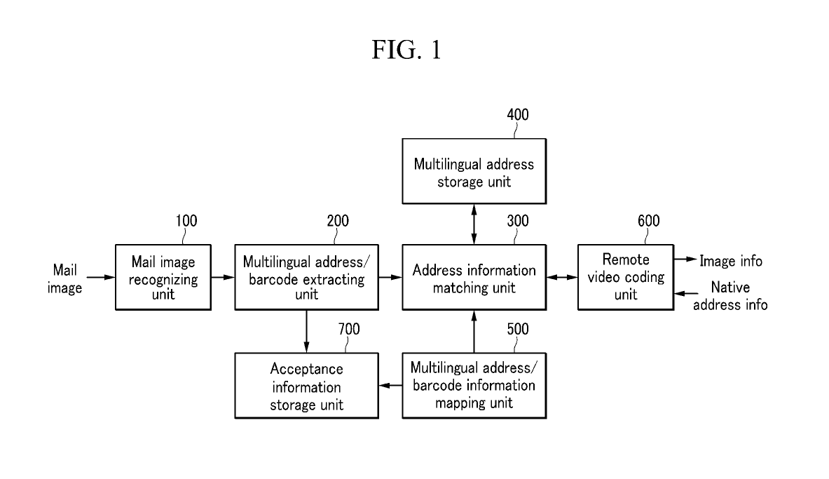

First, a multilingual acceptance information processing system will now be described with reference to FIG. 1.

FIG. 1 shows a configuration diagram of an image recognition-based multilingual acceptance information processing system according to an exemplary embodiment of the present invention.

As shown in FIG. 1, the multilingual acceptance information processing system includes a mail image recognizing unit 100, a multilingual address/barcode extracting unit 200, a address information matching unit 300, a multilingual address storage unit 400, a multilingual address/barcode information mapping unit 500, a remote video coding unit 600, and an acceptance information storage unit 700.

The mail image recognizing unit 100 recognizes image information of mail that is sequentially input through a conveyor, and transmits the same to the multilingual address/barcode extracting unit 200. Here, the image information includes address information and barcode information, and the barcode information includes a serial number of the barcode to be identified from another barcode, mailer's information, acceptance date, and country code.

The multilingual address/barcode extracting unit 200 separates the address information and the barcode information from the image information transmitted by the mail image recognizing unit 100, and transmits the address information to the address information matching unit 300 and the barcode information to the acceptance information storage unit 700. In this instance, when it is determined that image information includes no barcode information, the multilingual address/barcode extracting unit 200 generates a new serial number, generates a barcode to be attached on mail based on the serial number, and provides the barcode to the acceptance information storage unit 700 so that it may be mapped with address information written in a native language, that is, native address information, to be converted and extracted.

Since the address information provided by the multilingual address/barcode extracting unit 200 is written in a foreign language, the address information matching unit 300 inquires the multilingual address storage unit 400 storing native address information to acquire correct native address information for the address information written on the mail. Here, since the inquiry method is already known to a skilled person, a detailed description thereof will be omitted in the exemplary embodiment of the present invention.

Upon receiving a failure message on recognition of correct native address information from the multilingual address storage unit 400, the address information matching unit 300 transmits address information to the remote video coding unit 600 to acquire native address information correctly recognized by a specialist from a remote video coding center (not shown).

The multilingual address storage unit 400 is configured with a plurality of databases, and it maps native address information on multiple languages and stores the same. Also, when the address information matching unit 300 requests an inquiry of address information and the multilingual address storage unit 400 stores native address information corresponding to the address information provided by the address information matching unit 300, the multilingual address storage unit 400 transmits the corresponding native address information to the address information matching unit 300. However, when failing to find the correct native address information corresponding to the address information, the multilingual address storage unit 400 transmits a message for notifying that address recognition has failed to the address information matching unit 300 so as to acquire correctly recognized native address information through a specialist in the remote video coding center.

Upon receiving image information on the mail from the address information matching unit 300, the remote video coding unit 600 transmits the image information to the specialist of the video coding center in the remote place to request that the correct native address may be manually extracted. When receiving the native address information from the video coding center, the remote video coding unit 600 transmits the same to the address information matching unit 300.

The multilingual address/barcode information mapping unit 500 receives address information and information on which corresponding native address information is mapped from the multilingual address storage unit 400, connects address information and barcode information in connection with the acceptance information storage unit 700, and assigns a postal code corresponding to the native address information.

The acceptance information storage unit 700 stores barcode information extracted from the multilingual address/barcode extracting unit 200, and provides information so that it may be connected with the native address information by the multilingual address/barcode information mapping unit 500. The acceptance information storage unit 700 stores the postal code assigned by the multilingual address/barcode information mapping unit 500 as acceptance information together with native address information and barcode information so that the user (mailman, etc.) may check the mail address written in a native language by recognizing the barcode in a subsequent logistics process.

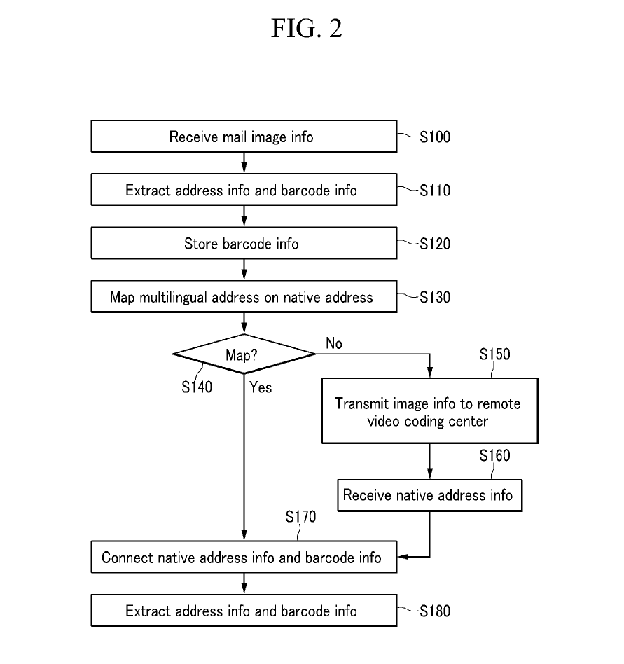

A process for processing mail by using the above-described system will now be described with reference to FIG. 2.

FIG. 2 shows a flowchart of a method for processing mail by using the system according to the exemplary embodiment of the present invention.

As shown in FIG. 2, the mail image recognizing unit 100 receives image information of the mail that is sequentially entered through the conveyor (S100), and the multilingual address/barcode extracting unit 200 extracts address information and barcode information from the received image information (S110). The multilingual address/barcode extracting unit 200 transmits the extracted barcode information to the acceptance information storage unit 700 to store the barcode information (S120). In this instance, when determining that the mail includes no barcode, the multilingual address/barcode extracting unit 200 generates a new serial number, generates a barcode to be attached on mail based on the serial number, and provides the barcode to the acceptance information storage unit 700 so that it is stored in the unit 700.

The multilingual address/barcode extracting unit 200 transmits the extracted address information to the address information matching unit 300 so that the address information written in a foreign language may be mapped on the native address information. The address information matching unit 300 maps the address information received from the multilingual address/barcode extracting unit 200 on native address information stored in the multilingual address storage unit 400 (S130).

In this instance, the address information matching unit 300 determines whether the received address information is correctly mapped as native address information (S140). When it is determined that the received address information is mapped as the native address information since the native address information corresponding to the received address information is obtained from the multilingual address storage unit 400, the address information matching unit 300 transmits the native address information to the multilingual address/barcode information mapping unit 500 to connect the same with the barcode information stored in the acceptance information storage unit 700 in S120 (S170).

However, when the received address information is not mapped as the native address information, the address information matching unit 300 transmits the image information to the remote video coding unit 600. The remote video coding unit 600 transmits the image information to the remote video coding center (S150). The image information may be converted into native address information by a user such as a specialist staying in the remote video coding center, but it is not restricted thereto. The native address information corresponding to the image information is transmitted to the remote video coding unit 600 (S160). The remote video coding unit 600 provides the native address information to the address information matching unit 300 so that the native address information may be matched with address information.

When the native address information is connected to the barcode information (S170), the multilingual address/barcode information mapping unit 500 assigns a postal code for the native address information, and transmits acceptance information (native address information, barcode information, and postal code) to the acceptance information storage unit 700 (S180). Since address information written in multiple languages is analyzed into native address information, mapped with the barcode, and stored in the acceptance information storage unit 700 through the above-noted process, the mail address translated into a native language can be checked through barcode reading in the distribution process.

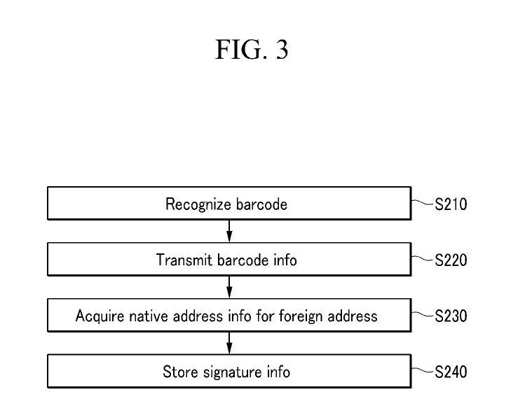

A method for converting the multilingual address information into native address information and checking the mail address corresponding to the native address information through barcode scanning when the mailman actually delivers the mail will now be described with reference to FIG. 3.

FIG. 3 shows a flowchart of a method for a mailman to deliver mail according to an exemplary embodiment of the present invention.

As shown in FIG. 3, when the mailman receives mail according to various processes such as a mail sorting process, the barcode printed on the mail is recognized by using a barcode reader (S210). The recognized barcode information is transmitted to the acceptance information storage unit 700 (S220), and the acceptance information storage unit 700 transmits native address information and postal code information corresponding to the received barcode information to the mailman (S230).

The mailman delivers the mail based on the native address information and the postal code information. When the mail recipient signs to receive a normal mail delivery, the signature information together with address information, native address information, postal code information, and barcode information is stored in the acceptance information storage unit 700 (S240).

According to the embodiments of the present invention, when the international mail arrives, the recipient address can be interpreted automatically through the multilingual character recognition skill, and the job processing rate as well as the operator's productivity is improved by substituting the translation through mapping with the barcode.

Also, when the mailman reads the barcode in the final delivery process, a detailed native address is displayed on the mailman's display device, and hence, the international mail can be processed with a similar work load to that of domestic registered mail, thereby improving the work load of the international mail.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A multilingual acceptance information processing system comprising:
a mail image recognizing unit for recognizing image information of input mail, the image information including address information of the mail and barcode information of the mail;
a multilingual address/barcode extracting unit for receiving image information from the mail image recognizing unit and extracting address information and barcode information of the mail form the image information;
an address information matching unit for receiving the address information extracted by the multilingual address/barcode extracting unit, comparing the received address information with pre-stored native address information mapped on multilingual languages, and extracting native address information corresponding to the address information; and
a multilingual address/barcode information mapping unit for assigning a postal code corresponding to the native address information extracted by the address information matching unit, mapping the native address information and the barcode information, and generating acceptance information including the postal code.

2. The multilingual acceptance information processing system of claim 1, wherein the system includes:
an acceptance information storage unit for receiving the barcode information extracted by the multilingual address/barcode extracting unit, storing the barcode information, and storing acceptance information generated by the multilingual address/barcode information mapping unit;
a multilingual address storage unit for storing native address information, which is mapped on multilingual languages, compared with the address information by the address information matching unit; and
a remote video coding unit for transmitting the image information to an remote video coding center when the address information matching unit fails to extract the native address information corresponding to the address information, receiving native address information for the address information from the remote video coding center, and transmitting the same to the address information matching unit.

3. A multilingual acceptance information processing method comprising:
extracting address information and barcode information from image information when collecting the image information of mail;
determining whether native address information is extracted by mapping the extracted address information and pre-stored native address information mapped on multilingual languages;
generating acceptance information on the mail in connection with the native address information and the barcode information when native address information corresponding to the address information is extracted; and
storing the generated acceptance information.

4. The multilingual acceptance information processing method of claim 3, wherein,
when native address information corresponding to the address information is not extracted:
requesting native address information corresponding to the address information by transmitting the image information to a remote video coding center;
receiving native address information corresponding to the address information from the remote video coding center; and
generating acceptance information for the mail in connection with the received native address information and the barcode information.

5. The multilingual acceptance information processing method of claim 3, wherein
the determining includes
storing the extracted barcode information in an acceptance information storage unit.

6. The multilingual acceptance information processing method of claim 3, wherein
the generating of acceptance information includes
assigning a postal code corresponding to the native address information.

7. The multilingual acceptance information processing method of claim 3, wherein the method includes,
when receiving a request for providing native address information corresponding to the barcode information after the storing of acceptance information:
extracting acceptance information including barcode information matching the requested barcode information from among the stored acceptance information;
transmitting native address information included in the extracted acceptance information; and
storing signature information for notifying delivery of mail corresponding to the acceptance information together with the acceptance information.
